(19) United States
(12) Patent Application Publication
(10) Pub. No.: US 2026/0336654 A1
(43) Pub. Date: Oct. 29, 2026

(54) INFORMATION COMMUNICATION DEVICE

(71) Applicant: SUBARU CORPORATION, Tokyo (JP)

(72) Inventors: Takanori TATEBE, Tokyo (JP); Naoto YABUKI, Tokyo (JP); Kazuki FURUKAWA, Tokyo (JP)

(21) Appl. No.: 19/120,155

(22) PCT Filed: Jul. 31, 2023
(86) PCT No.: PCT/JP2023/027931

§ 371 Date: Apr. 10, 2025

(30) Foreign Application Priority Data
Nov. 28, 2022 (JP) 2022-188851

(51) Int. Cl. B60W 50/16; B60K 35/25; B60K 35/26; B60W 50/00

(52) U.S. Cl. CPC B60W 50/16; B60K 35/25; B60K 35/26; B60W 2050/0022; B60W 2510/083; B60W 2510/18; B60W 2540/106; B60W 2540/12

(57) ABSTRACT

An information communication device configured to be provided in a vehicle that includes a drive device and a braking device includes a parameter detector, a vibration waveform generator, a vibrator, and a gain adjuster. The drive device is configured to drive a wheel of the vehicle. The braking device is configured to brake the wheel. The parameter detector is configured to detect a parameter that correlates with one or both of a driving force of the drive device and a braking force of the braking device. The vibration waveform generator is configured to generate a vibration waveform. The vibrator is configured to cause vibration of air around an occupant with the vibration waveform. The gain adjuster is configured to increase an output gain of the vibration waveform in accordance with an increase in an absolute value of a differential value of the parameter.

### CROSS-REFERENCE TO RELATED APPLICATIONS

This application is the U.S. National Phase under 35 U.S.C. § 371 of International Application No. PCT/JP2023/027931, filed on Jul. 31, 2023, which claims the benefit of foreign priority to Japanese Patent Application No. 2022-188851 filed on Nov. 28, 2022, the entire contents of each of which are hereby incorporated by reference.

### TECHNICAL FIELD

The invention relates to an information communication device that communicates information on a behavior of a vehicle to an occupant of the vehicle.

### BACKGROUND ART

As a technique related to outputting a sound to an occupant of a vehicle such as an automobile in accordance with a state of the vehicle, for example, Patent Literature 1 discloses a driver assistance apparatus configured to easily recognize a steering angle and a steering direction. The driver assistance apparatus indicates a steering amount of a steering wheel with a sound that changes in conjunction with the steering amount.

Specifically, Patent Literature 1 discloses that the steering amount of the steering wheel is indicated by performing control that raises a musical scale as the steering amount becomes larger, or changing, for example, an intensity of the sound, a pitch of the sound, a timbre of the sound, a sound pressure of the sound, a frequency of the sound, or a position of a sound image.

Patent Literature 2 discloses a vehicle music generation apparatus that generates music reflecting a behavior of a vehicle and an operation performed by a driver in a simple way. The vehicle music generation apparatus includes a storage unit and a control unit. The storage unit holds multiple sound source loop patterns corresponding to respective pieces of information that are based on the behavior of the vehicle or the operation performed by the driver on the vehicle. The control unit selects a specified sound source loop pattern from among the multiple sound source loop patterns in accordance with the corresponding piece of information, and performs control of outputting the selected sound source loop pattern or stopping outputting the selected sound source loop pattern.

### CITATION LIST

### Patent Literature

Patent Literature 1: Japanese Unexamined Patent Application Publication No. 2007-62706
Patent Literature 2: Japanese Unexamined Patent Application Publication No. 2016-66912

### SUMMARY OF INVENTION

### Problem to be Solved by the Invention

There is a time response delay between an acceleration operation or a brake operation (hereinafter, collectively referred to as an acceleration and deceleration operation) of a vehicle and actual occurrence of a behavior of a vehicle body that generates, for example, a longitudinal acceleration rate and a pitch angle. Some situations of a steering operation thus may possibly cause an occupant to feel that, for example, the longitudinal acceleration rate is generated abruptly and to experience discomfort or anxiety due to, for example, being unable to appropriately hold his/her body.

To address this, for example, some measures are conceivable such as lowering responsiveness to the acceleration and deceleration operation of the vehicle or enhancing holding performance of a seat or the like that holds the occupant.

However, the lowered responsiveness to the acceleration and deceleration operation slows the behavior of the vehicle to thereby impair performance and merchantability of the vehicle. Further, the measures using the seat have a difficulty in appropriately dealing with occupants of various body shapes.

In view of the above-described problems, an object of the invention is to provide an information communication device that improves predictability of an occupant for a behavior caused by acceleration and deceleration of a vehicle.

### Means for Solving the Problem

To solve the above-described problems, an aspect of the invention provides an information communication device configured to be provided in a vehicle. The vehicle includes a drive device and a braking device. The drive device is configured to drive a wheel of the vehicle. The braking device is configured to brake the wheel. The information communication device includes a parameter detector, a vibration waveform generator, a vibrator, and a gain adjuster. The parameter detector is configured to detect a parameter that correlates with one or both of a driving force of the drive device and a braking force of the braking device. The vibration waveform generator is configured to generate a vibration waveform. The vibrator is configured to cause vibration of air around an occupant with the vibration waveform. The gain adjuster is configured to increase an output gain of the vibration waveform in accordance with an increase in an absolute value of a differential value of the parameter.

### BRIEF DESCRIPTION OF DRAWINGS

FIG. 1 is a diagram schematically illustrating a system configuration of a vehicle including an information communication device according to a first embodiment of the invention.

FIG. 2 is a schematic diagram illustrating a configuration of a pedal according to the first embodiment.

FIG. 3 is a diagram schematically illustrating a system configuration of the information communication device according to the first embodiment.

FIGS. 4(a) and 4(b) are graphs schematically illustrating examples of a vibration waveform according to the first embodiment.

FIG. 5 is a chart schematically illustrating respective timings of electrical pulses emitted by receptors upon receiving stimuli.

FIG. 6 is a diagram illustrating respective distributions of sensitivity to a frequency of Pacini's corpuscles and Meissner's corpuscles.

FIG. 7 is a graph schematically illustrating an example of gain adjustment performed by a first gain adjuster according to the first embodiment.

FIG. 8 is a graph schematically illustrating an example of an output history of a microphone according to the first embodiment.

FIG. 9 is a graph illustrating an example of a correlation between a sound pressure and a frequency of background noise according to the first embodiment.

FIG. 10 is a graph schematically illustrating an example of gain adjustment performed by a second gain adjuster according to the first embodiment.

FIG. 11 is a diagram schematically illustrating arrangement inside a vehicle compartment of the vehicle provided with the information communication device according to the first embodiment.

### MODES FOR CARRYING OUT THE INVENTION

### First Embodiment

In the following, an information communication device according to a first embodiment of the invention will be described.

The information communication device according to the first embodiment is provided in, for example, an automobile (a vehicle) such as a passenger car, and communicates information on a behavior accompanied by acceleration and deceleration of the vehicle to an occupant such as a driver or a passenger.

In the first embodiment, the vehicle includes a pedal operation device that performs an acceleration operation (an accelerator operation) and a slow braking operation with a regenerative power generation brake upon driver's operation on a single pedal.

The vehicle is, for example, an electric vehicle such as a battery electric vehicle (BEV), an engine/electric hybrid vehicle (HEV), or a fuel cell vehicle (FCV). The BEV, the HEV, and the FCV each include a motor generator including, for example, a permanent magnet synchronous motor, a wound field synchronous motor, or an induction motor as a traveling power source.

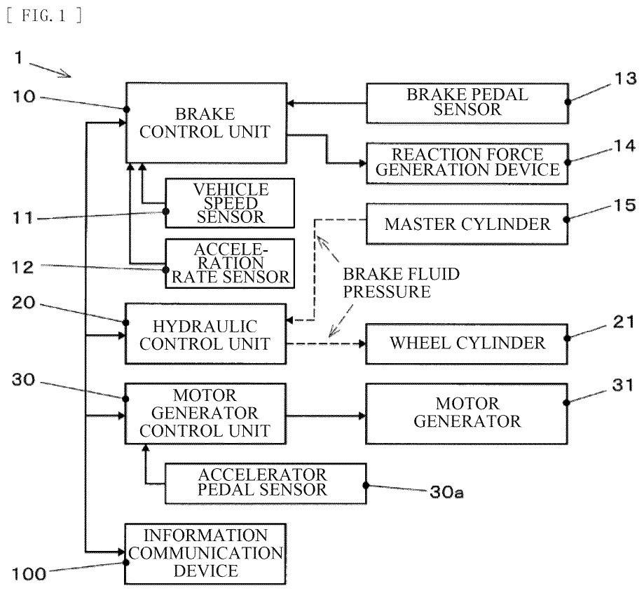

FIG. 1 is a diagram schematically illustrating a system configuration of the vehicle including the information communication device according to the first embodiment.

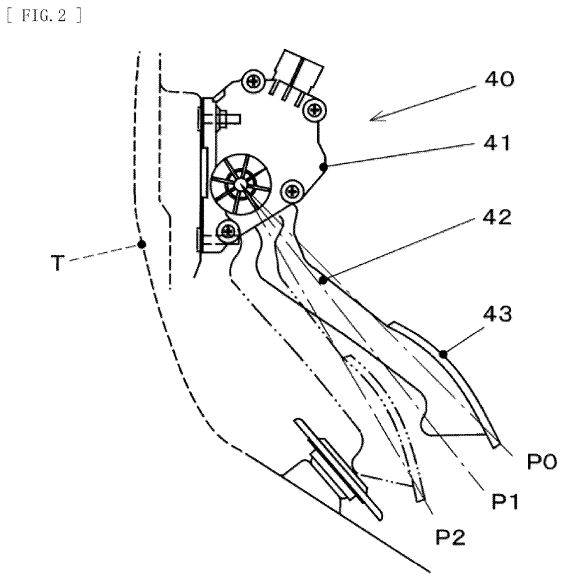

FIG. 2 is a schematic diagram illustrating a configuration of a pedal according to the first embodiment.

A vehicle 1 includes, for example, a brake control unit 10, a hydraulic control unit 20, a motor generator control unit 30, an accelerator pedal 40 (see FIG. 2), and an information communication device 100.

These units each include a microcontroller including, for example, an information processor such as a CPU, a storage such as a RAM or a ROM, an input/output interface, and a bus that couples these components to each other.

Further, these units are configured to be coupled to each other directly or via an in-vehicle LAN such as a CAN communication system to thereby communicate with each other.

The brake control unit 10 performs cooperative control of a hydraulic friction brake and the regenerative power generation brake in accordance with an operation on an unillustrated brake pedal.

The brake control unit 10 also has functions of performing anti-lock brake control and behavior stabilization control.

The anti-lock brake control is performed to cyclically decrease a braking force being applied to wheels upon detecting a wheel lock in which rotation of the wheels is locked in braking.

The behavior stabilization control is performed to generate a yaw moment in a restorative direction by a difference in braking force between left and right wheels upon occurrence of an understeer behavior or an oversteer behavior.

To the brake control unit 10 is coupled a vehicle speed sensor 11, an acceleration rate sensor 12, a brake pedal sensor 13, and a reaction force generation device 14.

In addition, a brake device of the vehicle 1 further includes a master cylinder 15.

The vehicle speed sensor 11 is provided at an unillustrated hub bearing housing that rotatably supports the corresponding wheel. The vehicle speed sensor 11 generates a vehicle speed signal corresponding to a rotational angular velocity of the corresponding wheel.

The brake control unit 10 calculates a travel speed (a vehicle speed) of the vehicle 1, based on an output of the vehicle speed sensor 11.

The acceleration rate sensor 12 is provided at a so-called unsprung part of an unillustrated suspension device. The suspension device supports the wheel in such a manner that the wheel is able to be stroked relative to a vehicle body.

The acceleration rate sensor 12 detects, for example, a vertical acceleration rate of a component provided on an unsprung side, such as a suspension arm or the hub bearing housing.

The acceleration rate sensor 12 is a vibration input detector that detects a vibration input from a road surface.

The brake control unit 10 is further provided with, for example, an unillustrated vehicle body longitudinal acceleration rate sensor, vehicle body lateral acceleration rate sensor, and yaw rate sensor to perform the above-described behavior stabilization control, for example.

The brake pedal sensor 13 includes an encoder that detects an operation amount (a depressed amount) of the brake pedal.

In accordance with a command from the brake control unit 10, the reaction force generation device 14 generates a reaction force in a direction in which the brake pedal returns to its initial position (its undepressed position).

For example, upon employing the regenerative power generation brake, the reaction force generation device 14 generates a reaction force with a driving power source such as an electric actuator.

The master cylinder 15 pressurizes a brake fluid that is a working fluid of the friction brake, in accordance with a depressing operation on a depressed surface member of the brake pedal.

A brake fluid pressure generated by the master cylinder 15 is communicated to the hydraulic control unit 20 via a pipe.

The hydraulic control unit (HCU) 20 is a hydraulic control device having a function of individually regulating brake fluid pressures of respective wheel cylinders 21 of the wheels.

The hydraulic control unit 20 includes, for example, an electric pump, a pressure-increasing valve, a pressure-reducing valve, and a pressure-holding valve. The electric pump pressurizes the brake fluid. The pressure-increasing valve, the pressure-reducing valve, and the pressure-holding valve control the brake fluid pressures of the respective wheel cylinders.

To the hydraulic control unit 20 is coupled, for example, the master cylinder 15 and the wheel cylinders 21 via a brake fluid pipe.

The brake fluid pressure generated by the master cylinder 15 is communicated to the wheel cylinders 21 via the hydraulic control unit 20.

The hydraulic control unit 20 has a function of performing an override on the brake fluid pressure generated by the master cylinder 15 to thereby increase and decrease the brake fluid pressures of the respective wheel cylinders.

The wheel cylinders 21 are provided for the respective wheels. The wheel cylinders 21, for example, each press a brake pad against a disc rotor to thereby generate a frictional force (a braking force) corresponding to the brake fluid pressure.

When the brake control unit 10 generates or increases a control allocation ratio of the regenerative power generation brake (a braking device) in the regenerative cooperative control, the hydraulic control unit 20 further has a function of decreasing or blocking the brake fluid pressure to be communicated from the master cylinder 15.

In this case, the brake control unit 10 generates a reaction force of the brake pedal with the reaction force generation device 14 to give the driver a sensation simulating a sensation obtained in employing the hydraulic friction brake.

The brake control unit 10 further has a function of performing the slow braking (for example, having a deceleration rate of about 0.1 G to about 0.3 G) with the regenerative power generation brake in accordance with an operation of returning the accelerator pedal 40 from a predetermined position.

The motor generator control unit 30 comprehensively controls a motor generator 31 and auxiliary devices of the motor generator 31.

The motor generator 31 is a rotating electrical machine to be used as a traveling power source (a drive device) of the vehicle 1.

The motor generator control unit 30 includes, for example, an inverter. The inverter supplies the motor generator 31 with electric power supplied from a power supply such as a traveling battery.

The motor generator 31 may be mounted on, for example, the vehicle body (a sprung part) and may be configured to communicate a driving force to the wheels via, for example, a differential (a differential mechanism) and a drive shaft; however, this is non-limiting. For example, the motor generator 31 may be an in-wheel motor.

The motor generator control unit 30 performs switching between a driving mode and a regenerative power generation mode. The driving mode causes the motor generator 31 to generate output torque (the driving force). The regenerative power generation mode causes the motor generator 31 to perform the regenerative power generation to thereby absorb torque communicated from the wheels and generate a braking force.

In the driving mode, the motor generator control unit 30 performs such control that causes actual torque actually generated by the motor generator 31 to become equal to requested torque set based on, for example, an operation amount of the accelerator pedal 40.

In the regenerative power generation mode, the motor generator control unit 30 controls absorption torque to be absorbed by the motor generator 31, in accordance with a requested braking force commanded by the brake control unit 10.

The accelerator pedal 40 illustrated in FIG. 2 is a foot-depressible operation member with which the driver performs the accelerator operation and a brake operation.

The accelerator pedal 40 includes, for example, a bracket 41, a lever 42, and a depressed surface member 43.

The bracket 41 is a base that turnably supports the lever 42 around a rotating shaft extending in a vehicle width direction.

The bracket 41 includes an unillustrated spring that biases the lever 42 in its restorative direction (toward its initial position).

The bracket 41 is attached to a toe board T that is a partition wall provided in the front of a vehicle compartment.

The lever 42 is a member protruding downward and obliquely rearward from the bracket 41.

The depressed surface member 43 is a part that is provided at a tip (an opposite end from the bracket 41) of the lever 42 and is to come into contact with a sole of a foot of the occupant.

As illustrated in FIG. 2, the depressed surface member 43 is pivotable in its longitudinal direction around a fulcrum (a pivot) of the lever 42 adjacent to the bracket 41.

A neutral position P1 is set between an initial position PO and a fully open position P2. The initial position P0 is a position where the depressed surface member 43 is not pressed by the foot of the occupant. The fully open position P2 is a position where the depressed surface member 43 is depressed by the foot of the occupant until coming into contact with a stopper.

The accelerator pedal 40 performs the accelerator operation in a region from the neutral position P1 to the fully open position P2, and performs the brake operation in a region from the neutral position P1 to the initial position P0.

The braking force (deceleration G) by the regenerative power generation brake increases in accordance with an amount of displacement (an amount of return) from the neutral position P1 toward the initial position P0.

To the motor generator control unit 30 is coupled an accelerator pedal sensor 30a.

The accelerator pedal sensor 30a includes an encoder that detects a rotational angle position of the lever 42 of the accelerator pedal 40.

The accelerator pedal sensor 30a is provided at the bracket 41.

The motor generator control unit 30 detects a stroke S of the depressed surface member 43 from the initial position, based on an output of the accelerator pedal sensor 30a.

The stroke S detected by the accelerator pedal sensor 30a is also communicated to the brake control unit 10 to control the regenerative power generation brake.

The accelerator pedal sensor 30a serves as a parameter detector according to the invention.

The information communication device 100 vibrates air around an ear of the occupant with a speaker 170 disposed in the vehicle compartment and notifies the occupant of a sign of occurrence of the behavior of the vehicle with an acoustic signal.

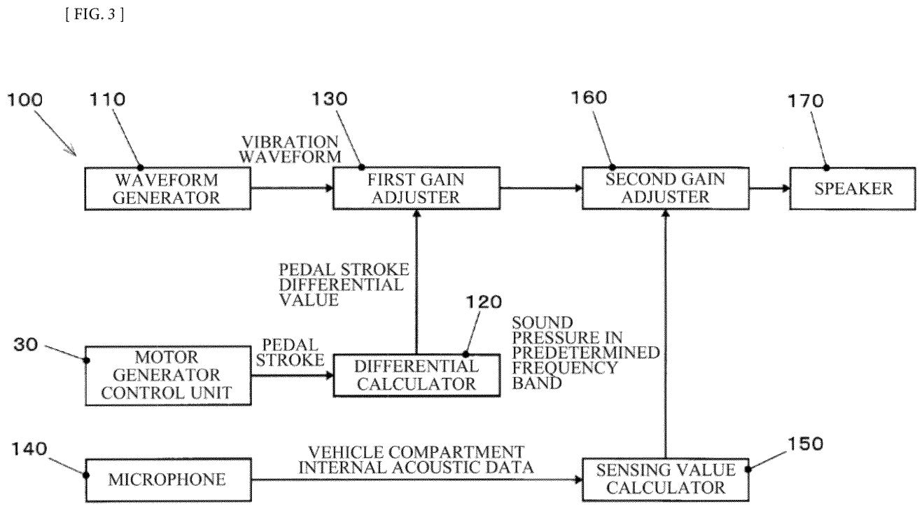

FIG. 3 is a diagram schematically illustrating a system configuration of the information communication device according to the first embodiment.

The information communication device 100 includes, for example, a waveform generator 110, a differential calculator 120, a first gain adjuster 130, a microphone 140, a sensing value calculator 150, a second gain adjuster 160, and the speaker 170.

The waveform generator 110 generates a vibration waveform that is a waveform of the acoustic signal to be generated by the speaker 170.

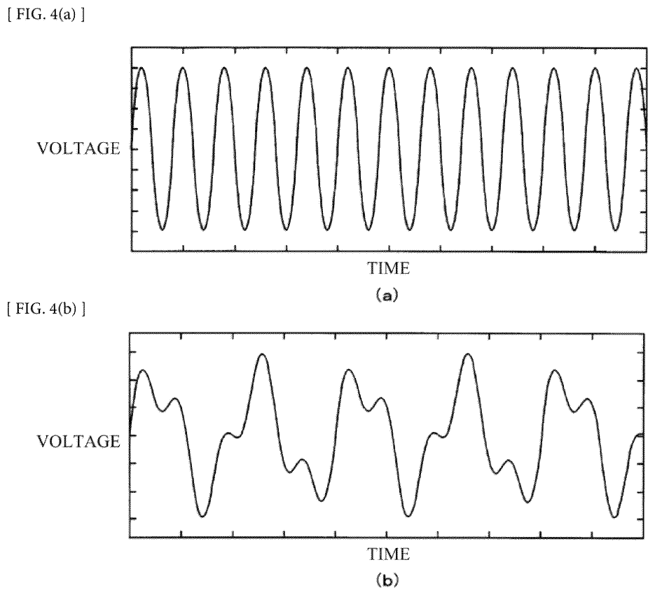

FIGS. 4(a) and 4(b) are graphs schematically illustrating examples of the vibration waveform according to the first embodiment.

In FIGS. 4(a) and 4(b), abscissa axes represent time, and ordinate axes represent a voltage (an amplitude).

For example, as illustrated in FIG. 4(a), the vibration waveform may be a sine wave.

Further, for example, as illustrated in FIG. 4(b), the vibration waveform may be a waveform in which multiple sine waves having different wavelengths are superimposed on (combined with) each other.

Furthermore, the vibration waveform is not limited to these waveforms and may be changed as appropriate.

For example, as the vibration waveform, various waveforms such as a square wave, a triangular wave, or a waveform simulating a traveling sound of the vehicle may be used alone or in combination with other waveforms.

In the first embodiment, a frequency of the vibration waveform may be set to have a dominant frequency in a range of, for example, 100 Hz to 400 Hz, more preferably 150 Hz to 300 Hz.

Reasons for this will be described below.

Sensory receptors that sense vibration when the air around the occupant is vibrated include, for example, Merkel's cells, Meissner's corpuscles, and Pacini's corpuscles.

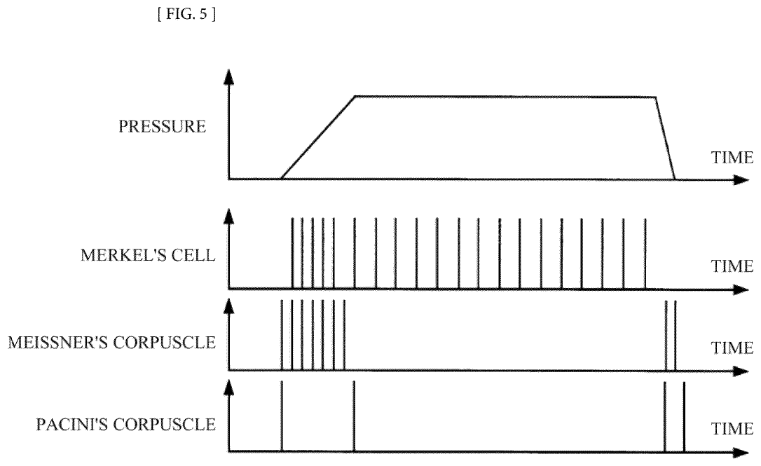

FIG. 5 is a chart schematically illustrating respective timings of electrical pulses emitted by the receptors upon receiving stimuli.

In FIG. 5, abscissa axes represent time, and ordinate axes represent a pressure, an electrical pulse generation state of the Merkel's cells, an electrical pulse generation state of the Meissner's corpuscles, and an electrical pulse generation state of the Pacini's corpuscles in order from the top.

The Merkel's cells are relatively slow in response and respond to a direct current component.

The Meissner's corpuscles respond to occurrence of a rate (a speed) of change in a contact pressure.

The Pacini's corpuscles respond to a transient change moment. The Pacini's corpuscles are considered as most sensitive of these receptors.

The sensitivity of the Pacini's corpuscles is considered as most favorable as the receptors with which the occupant perceives minute vibration as auditory and tactile composite information.

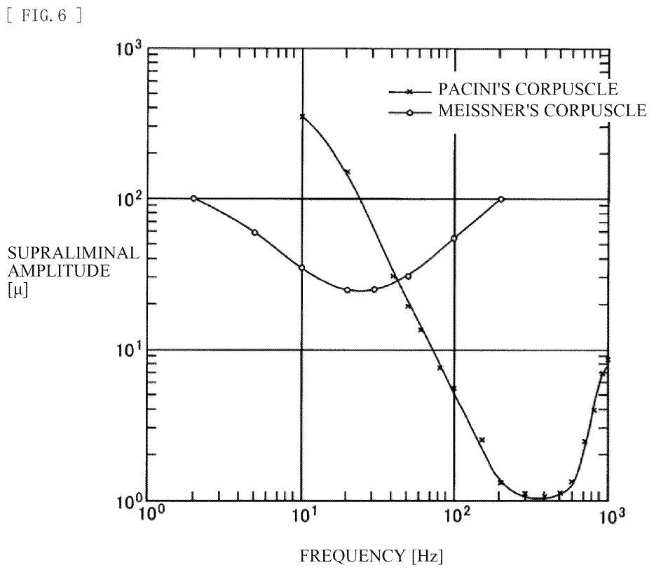

FIG. 6 is a diagram illustrating respective distributions of sensitivity to a frequency of the Pacini's corpuscles and the Meissner's corpuscles.

In FIG. 6, an abscissa axis represents the frequency, and an ordinate axis represents a supraliminal amplitude. A smaller value of the supraliminal amplitude represents higher sensitivity.

As illustrated in FIG. 6, the Pacini's corpuscles exhibit favorable sensitivity in a region of about 100 Hz to about 400 Hz, particularly more favorable sensitivity in a region of 150 Hz to 300 Hz.

These regions are included in a range of 20 Hz to 20 kHz that is typically considered as a human audible range.

The dominant frequency of the vibration waveform may be set to 250 Hz, for example.

The differential calculator 120 acquires information on the stroke S of the accelerator pedal 40 detected by the accelerator pedal sensor 30a from the motor generator control unit 30, and calculates a differential value ΔS differentiated by time.

The differential calculator 120 successively communicates the calculated differential value ΔS to the first gain adjuster 130.

The first gain adjuster 130 performs first gain adjustment to be described below on a fundamental wave of the vibration waveform generated by the waveform generator 110.

The first gain adjustment is performed to change a gain G1 that is an output gain by which the voltage of the vibration waveform is to be multiplied, depending on the differential value ΔS (a change rate per hour) of the stroke S (a parameter that correlates with one or both of the driving force and the braking force) of the accelerator pedal 40.

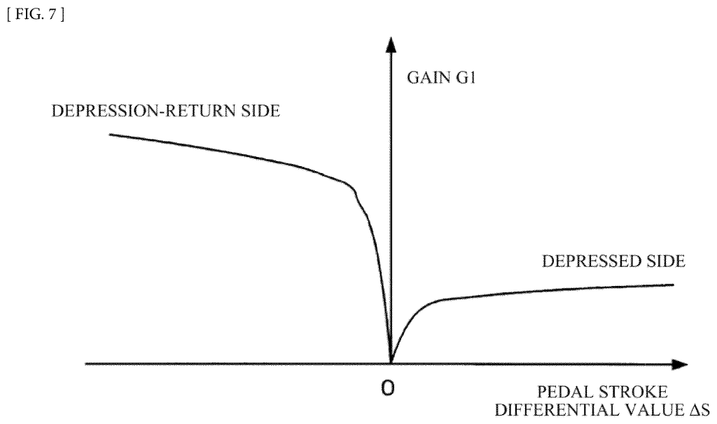

FIG. 7 is a graph schematically illustrating an example of the gain adjustment performed by the first gain adjuster.

In FIG. 7, an abscissa axis represents the differential value ΔS of the stroke S of the accelerator pedal 40, and an ordinate axis represents the gain G1 by which the voltage of the vibration waveform is to be multiplied.

The gain G1 may be configured to increase in accordance with an increase in an absolute value of the differential value ΔS.

Further, the first gain adjuster 130 may be configured to maximize an increase rate of the gain G1 relative to the increase in the absolute value of the differential value ΔS in a region where the absolute value of the differential value ΔS is minute, and decrease the increase rate in accordance with the increase in the absolute value of the differential value ΔS.

Furthermore, in comparison between a depressed side and a return side of the accelerator pedal 40, the gain G1 is set to be larger on the return side (for a deceleration operation) than on the depressed side (for the acceleration operation) if the absolute value of the differential value ΔS is equivalent between both sides.

The depressed side and the return side of the accelerator pedal 40 are distinguishable from each other, based on a sign of the differential value ΔS.

The gain G1 by the first gain adjuster 130 may be calculated, for example, based on the absolute value of the differential value ΔS of the stroke S using a logarithmic function.

The gain G1 is expressed by, for example, Expression 1 below.

Gain G1=log (absolute value of stroke differential value ΔS×coefficient k) (Expression 1)

The coefficient k may be a value that is set, for example, at a development stage of the vehicle, in accordance with characteristics (for example, characteristics of the driving force or the braking force relative to a change in the stroke S, or a barycentric position) of the vehicle.

The microphone 140 is a sound collection device that is provided in the vehicle compartment and collects background noise in the vehicle compartment.

The microphone 140 is preferably disposed at a position close to the ear of the occupant, and may be provided on, for example, a headrest of a seat.

An output of the microphone 140 is communicated to the sensing value calculator 150.

The sensing value calculator 150 extracts a component of a predetermined frequency band from the background noise of the vehicle acquired by the microphone 140, and communicates a sound pressure of the extracted component as a sensing value to the second gain adjuster 160.

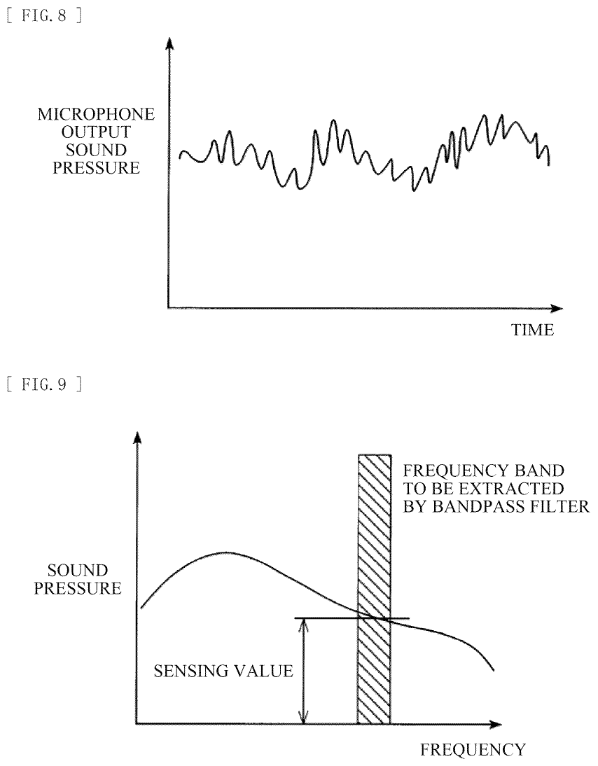

FIG. 8 is a graph schematically illustrating an example of an output history of the microphone.

In FIG. 8, an abscissa axis represents time, and an ordinate axis represents the sound pressure of the background noise acquired by the microphone 140.

The sensing value calculator 150 performs fast Fourier transform (FFT) processing on an acoustic signal of the background noise acquired by the microphone 140 to thereby convert the resultant acoustic signal into a frequency domain, and further performs bandpass filter processing on the frequency domain to thereby extract a component in a predetermined frequency band.

The frequency band to be extracted is set to include the dominant frequency of the vibration waveform to be outputted by the waveform generator 110.

The sensing value calculator 150 sets an average sound pressure in the extracted frequency band to the sensing value to be used for second gain adjustment.

FIG. 9 is a graph illustrating an example of a correlation between the sound pressure and the frequency of the background noise.

In FIG. 9, an abscissa axis represents the frequency, and an ordinate axis represents the sound pressure.

The bandpass filter may be configured to extract, for example, the frequency band adjacent to the dominant frequency (for example, 250 Hz) of the vibration waveform of the waveform generator 110.

The sound pressure in the extracted frequency band (for example, an average value in the frequency band) is provided as the sensing value to the second gain adjuster 160.

The second gain adjuster 160 further performs the second gain adjustment to be described below on the vibration waveform having been subjected to the first gain adjustment.

The second gain adjustment is performed to change the gain of the vibration waveform in accordance with the sensing value of the vehicle compartment internal noise to regulate an output amplitude of the vibration waveform in accordance with a change in the background noise (such as drivetrain noise, aerodynamic noise, or road noise) in traveling of the vehicle.

The second gain adjuster 160 performs the second gain adjustment, based on an output of the sensing value calculator 150.

The second gain adjuster 160 sets the gain G2, based on the sensing value outputted by the sensing value calculator 150.

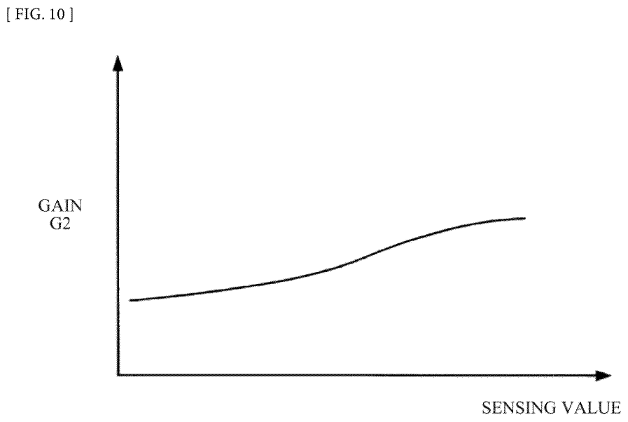

FIG. 10 is a graph schematically illustrating an example of the gain adjustment performed by the second gain adjuster.

In FIG. 10, an abscissa axis represents the sensing value, and an ordinate axis represents the gain G2 by which the voltage of the vibration waveform is to be multiplied.

The gain G2 may be configured to increase in accordance with an increase in the sensing value.

The gain G2 is set to cause a sound pressure of audio of a vibration amplitude outputted from the speaker 170 not to become dominant over the sound pressure of the background noise near the ear of the occupant.

Preferably, the gain G2 may be set to cause the audio of the vibration amplitude to be hidden in the background noise of the vehicle and have a sound pressure level subconsciously audible by the occupant.

An output value (a voltage) A of the vibration waveform having been subjected to the first gain adjustment and the second gain adjustment described above is expressed by Expression 2 below.

Output value A=output value of waveform generator×gain G1×gain G2=output value of waveform generator×log (absolute value of stroke differential value ΔS×coefficient k)×gain G2 (Expression 2)

The speaker 170 is a vibration device that is disposed in the vehicle compartment and vibrates the air around the occupant in the vehicle compartment to thereby generate audio, based on the output value A.

Arrangement of the speaker 170 will be described below in detail.

The speaker 170 may be configured to serve also as a speaker to be used for audio reproduction or the like by an in-vehicle audio device, for example.

Further, a speaker 170 dedicated to the information communication device 100 may be provided.

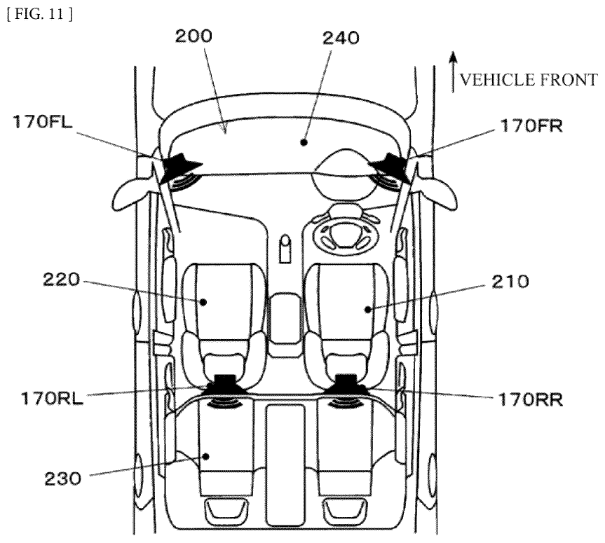

FIG. 11 is a diagram schematically illustrating arrangement inside the vehicle compartment of the vehicle provided with the information communication device according to the first embodiment.

The inside of a vehicle compartment 200 is provided with, for example, a driver's seat 210, a front passenger seat 220, a rear seat 230, and an instrument panel 240.

The driver's seat 210 and the front passenger seat 220 are each a front seat provided in the front of the vehicle compartment.

The driver's seat 210 and the front passenger seat 220 are provided side by side in the vehicle width direction.

In the example illustrated in FIG. 10, the vehicle is, for example, a so-called right-hand drive vehicle in which the driver's seat 210 is provided on a right side relative to a lateral center of the vehicle body and the front passenger seat 220 is provided on a left side relative to the lateral center of the vehicle body.

The driver's seat 210 and the front passenger seat 220 each include a cushion, a seat back, and a headrest. An occupant rests his/her buttocks and thighs on the corresponding cushion. The seat back is disposed behind a back of the corresponding occupant. The headrest is provided behind a head of the corresponding occupant.

The rear seat 230 is a bench-shaped seat disposed behind the driver's seat 210 and the front passenger seat 220.

The rear seat 230 allows, for example, two occupants to be seated side by side.

The rear seat 230 includes cushions, seat backs, and headrests. The occupants each rest his/her buttocks and thighs on the corresponding cushion. The seat backs are each disposed behind a back of the corresponding occupant. The headrests are each provided behind a head of the corresponding occupant.

The rear seat 230 includes a right seat area disposed behind the driver's seat 210 and a left seat area disposed behind the front passenger seat 220.

The instrument panel 240 is a member that is provided adjacent to a front end of the vehicle compartment 200 and houses, for example, a meter display, a ventilating/air conditioning/heating device, and an infotainment device.

The instrument panel 240 is disposed to oppose the respective occupants who are seated on the driver's seat 210 and the front passenger seat 220.

In the example illustrated in FIG. 11, for example, four respective speakers 170 are provided separately in the front and back of the vehicle compartment 200 and on the left and right of the vehicle compartment 200, for example.

Hereinafter, the speakers 170 will be described with reference numerals having letters corresponding to respective positions.

A right front speaker 170FR is disposed adjacent to a right end of the instrument panel 240.

The speaker 170FR is a directional speaker that is directed toward the head (an ear) of the occupant who is seated on the driver's seat 210.

A left front speaker 170FL is disposed adjacent to a left end of the instrument panel 240.

The speaker 170FL is a directional speaker that is directed toward the head (an ear) of the occupant who is seated on the front passenger seat 220.

A right rear speaker 170RR is disposed on the headrest of the driver's seat 210.

The speaker 170RR is a directional speaker that is directed toward the head (an ear) of the occupant who is seated on the right side of the rear seat 230.

A left rear speaker 170RL is disposed on the headrest of the front passenger seat 220.

The speaker 170RL is a directional speaker that is directed toward the head (an ear) of the occupant who is seated on the left side of the rear seat 230.

The above-described configuration of the first embodiment causes audio of an amplitude corresponding to the differential value ΔS of the stroke S to be emitted from the speaker 170 to the occupant when the driver performs the depressing operation (the acceleration operation) or the return operation (the deceleration operation) on the accelerator pedal 40 to thereby change the stroke S of the accelerator pedal 40.

The audio is masked by the traveling sound (the background noise) of the vehicle and is thus difficult to consciously recognize by the occupant as a sound, but allows the occupant to subconsciously predict the occurrence of the behavior of the vehicle involving generation of a longitudinal acceleration rate and pitching.

According to the first embodiment described above, the following effects are obtainable.

(1) Audio is generated of which the sound pressure is increased in accordance with the increase in the absolute value of the differential value AS of the stroke S of the accelerator pedal 40 serving as the parameter that correlates with one or both of the driving force of the motor generator 31 and the braking force of the regenerative power generation brake. Such audio allows the occupant to predict the occurrence of the behavior on an initial phase of the acceleration and deceleration of the vehicle prior to actual generation of, for example, the longitudinal acceleration rate and a pitch angle on the vehicle.

This configuration makes it possible to improve predictability of the occupant for the behavior of the vehicle and prevent the occupant from feeling that the behavior of the vehicle is abrupt.

This allows the occupant to prepare for the generation of, for example, an acceleration rate by tightening his/her body, for example. This prevents, for example, unintentional loss of a sitting posture.

(2) The vibration waveform has the dominant frequency included in a frequency band of 100 Hz to 400 Hz, more preferably 150 Hz to 300 Hz. This configuration enables use of, for example, the Pacini's corpuscles that are highly sensitive in the audible range and a skin sensation, allowing the occupant to favorably sense the sound through acoustics and recognize the skin sensation. This makes it possible to communicate the information to the occupant more reliably.
(3) The gain G1 is set based on the absolute value of the differential value ΔS of the stroke S of the accelerator pedal 40 using the logarithmic function. This configuration enables a large gain G1 to be set even in a region where the absolute value of the differential value ΔS is relatively small. This makes it possible to communicate the information to the occupant appropriately even on the initial phase of the acceleration and deceleration where the stroke S and the differential value ΔS are each minute.

The configuration further allows for preventing the output gain from becoming excessively large in a region where the absolute value of the differential value ΔS is large.

(4) The gain G2 is set to allow the sound pressure generated by the vibration caused by the speaker 170 not to become dominant over the background noise near an ear of at least one occupant in traveling of the vehicle. This configuration allows the audio generated by the vibration caused by the speaker 170 to be covered by the background noise of the vehicle. This makes it possible to prevent the occupant from feeling that the audio is unpleasant to the ear and communicate the information to the occupant appropriately.
(5) In performing the acceleration operation in accordance with the operation of depressing the single accelerator pedal 40 from a predetermined position and performing the braking operation in accordance with the operation of returning the accelerator pedal 40 from the predetermined position, the output gain set in accordance with the return operation is set to be larger than the output gain set in accordance with the depressing operation. This configuration makes it possible to increase the output gain on the return operation side of the pedal in which the driver has a difficulty in perceiving the reaction force. This allows the driver to predict the behavior of the vehicle accompanied by the deceleration appropriately.

### Second Embodiment

Next, an information communication device according to a second embodiment of the invention will be described.

In some embodiments described below, portions similar to those in the above-described embodiment will be denoted by the same reference numerals to omit description thereof, and differences will mainly be described.

The information communication device according to the second embodiment is provided in a vehicle that performs a drive operation (the acceleration operation) with the accelerator pedal and performs the braking operation (the deceleration operation) with the brake pedal alone independent of the accelerator pedal, instead of being configured to control the driving force and the braking force with the single pedal as in the first embodiment described above.

In the second embodiment, the information communication device sets the output gain of the vibration waveform corresponding to the differential value of the operation amount (the stroke) of the accelerator pedal independently of setting an output gain of a vibration waveform corresponding to a differential value of the operation amount (a stroke) of the brake pedal.

Note that the information communication device may be configured to perform output of the vibration waveform corresponding to the operation amount of the accelerator pedal and output of the vibration waveform corresponding to the operation amount of the brake pedal, either together or alone.

In the second embodiment described above, effects similar to the effects of the first embodiment described above (except for the effect described in Item (5)) are also obtainable.

### Third Embodiment

Next, an information communication device according to a third embodiment of the invention will be described.

In the third embodiment, the vehicle includes an automated driving function that performs, for example, a steering operation and an acceleration and deceleration operation autonomously without relying on a driving operation performed by the driver.

The vehicle according to the third embodiment further includes an unillustrated automated driving control unit in addition to the configuration of the vehicle according to the first embodiment.

The automated driving control unit recognizes an environment around the own vehicle using, for example, a high-precision 3D map or various sensors such as a stereo camera device, a millimeter wave radar device, or a laser scanner device.

The automated driving control unit generates, based on the recognized environment, an automated driving scenario including information on, for example, a traveling line and a speed of the own vehicle.

The automated driving control unit provides, based on the automated driving scenario, instructions to, for example, an electric power steering control unit 50, the motor generator control unit 30, and the brake control unit 10, to thereby control steering, acceleration, and deceleration of the vehicle.

In the third embodiment, the information communication device 100 uses, as inputs, a requested value of the driving force (a parameter that correlates with the driving force) provided from the automated driving control unit to the motor generator control unit 30 and a requested value of the braking force (a parameter that correlates with the braking force) provided from the automated driving control unit to the brake control unit 10, instead of the stroke S of the accelerator pedal 40 in the first embodiment.

For example, a requested torque value of the motor generator may be used as the requested value of the driving force.

For example, a target deceleration rate of the vehicle, a target brake fluid pressure of the hydraulic brake, or a regenerative power generation amount of the motor generator in employing the regenerative power generation brake may be used as the requested value of the braking force.

According to the third embodiment described above, even in the vehicle performing the automated driving, audio is generated in accordance with absolute values of the differential values of the respective parameters that correlate with the driving force and the braking force at the time of starting the acceleration and deceleration under the automated driving control. Such a configuration allows the occupant to predict the occurrence of the behavior of the vehicle involving the generation of, for example, the longitudinal acceleration rate and the pitch angle. This makes it possible to prevent the occupant from feeling that the behavior of the vehicle is abrupt.

### Modification Examples

The invention is not limited to the above-described embodiments, and various modifications and changes are possible. Such modifications and changes fall within the technical scope of the invention as well.

(1) The configurations of the information communication device and the vehicle are not limited to the above-described embodiments, and may be changed as appropriate.

For example, a hardware configuration of the information communication device and a specific method of the gain adjustment of the vibration waveform are not limited to the configuration of each of the embodiments, and may be changed as appropriate.

(2) In the first embodiment, for example, the stroke of the pedal is used as the parameter that correlates with the driving force of the drive device or the braking force of the braking device; however, the parameter is not limited to this parameter and may be changed as appropriate.

For example, requested torque (target torque) of the traveling power source may be used as the parameter that correlates with the driving force. When the traveling power source is an internal combustion engine, for example, an opening degree of a throttle valve or an amount of fuel injection may be used as the parameter that correlates with the driving force.

Further, for example, the brake fluid pressure of the hydraulic brake (typically a master cylinder fluid pressure), or the depressed amount (the stroke) or a depression force of the brake pedal that is depressibly operated by the foot to perform the braking operation is used as the parameter that correlates with the braking force.

(3) In each of the embodiments, for example, the level of the background noise of the vehicle is acquired by the microphone; however, the invention is not limited thereto and the level of the background noise may be acquired by any other method. For example, the level of the background noise may be estimated based on an acceleration rate of an unsprung part of the vehicle that correlates with an input from a road surface or an output value (torsion bar torque) of a torque sensor of a steering device.

An aspect of the invention provides an information communication device configured to be provided in a vehicle. The vehicle includes a drive device and a braking device. The drive device is configured to drive a wheel of the vehicle. The braking device is configured to brake the wheel. The information communication device includes a parameter detector, a vibration waveform generator, a vibrator, and a gain adjuster. The parameter detector is configured to detect a parameter that correlates with one or both of a driving force of the drive device and a braking force of the braking device. The vibration waveform generator is configured to generate a vibration waveform. The vibrator is configured to cause vibration of air around an occupant with the vibration waveform. The gain adjuster is configured to increase an output gain of the vibration waveform in accordance with an increase in an absolute value of a differential value of the parameter.

This configuration allows audio to be generated of which a sound pressure is increased in accordance with the increase in the absolute value of the differential value of the parameter that correlates with one or both of the driving force of the drive device and the braking force of the braking device. Such audio allows the occupant to predict occurrence of a behavior on an initial phase of acceleration and deceleration of the vehicle prior to actual generation of, for example, a longitudinal acceleration rate and a pitch angle on the vehicle.

This configuration makes it possible to improve predictability of the occupant for the behavior of the vehicle and prevent the occupant from feeling that the behavior of the vehicle is abrupt.

The vibration waveform may have a dominant frequency included in a frequency band of 100 Hz to 400 Hz.

This configuration enables use of, for example, Pacini's corpuscles that are highly sensitive in an audible range and a skin sensation, allowing the occupant to favorably sense the sound through acoustics and recognize the skin sensation. This makes it possible to communicate information to the occupant more reliably.

More preferably, the dominant frequency may be set to a frequency band of 150 Hz to 300 Hz here. This allows for use of a more favorable sensitivity region of the receptor, facilitating the above-described effects.

The gain adjuster may be configured to maximize an increase rate of the output gain relative to the increase in the absolute value of the differential value in a region where the absolute value of the differential value is minute, and decrease the increase rate in accordance with the increase in the absolute value of the differential value.

This configuration enables a large output gain to be set even in a region where the absolute value of the differential value is relatively small. This makes it possible to communicate the information to the occupant appropriately even on the initial phase of the acceleration and deceleration where a change in the driving force or the braking force is minute.

For example, the output gain may be set based on a logarithmic function of the absolute value of the differential value.

The gain adjuster may be configured to set the output gain to allow a sound pressure generated by the vibration caused by the vibrator not to become dominant over background noise near an ear of at least one of the occupant in traveling of the vehicle.

This configuration allows the audio generated by the vibration caused by the vibrator to be covered by background noise of the vehicle. This makes it possible to prevent the occupant from feeling that the audio is unpleasant to the ear and communicate the information to the occupant appropriately.

The vehicle may include an inputting device. The inputting device may be configured to perform an acceleration operation in accordance with an operation of depressing a single pedal from a predetermined position, and perform a braking operation in accordance with an operation of returning the single pedal from the predetermined position. The gain adjuster may be configured to set the output gain set in accordance with the operation of returning the single pedal to be larger than the output gain set in accordance with the operation of depressing the single pedal.

This configuration makes it possible to increase the output gain on a return operation side of the pedal in which the driver has a difficulty in perceiving a reaction force. This allows the driver to predict a behavior of a vehicle body accompanied by the deceleration appropriately.

1. An information communication device configured to be provided in a vehicle, the vehicle comprising a drive device and a braking device, the drive device being configured to drive a wheel of the vehicle, the braking device being configured to brake the wheel, the information communication device comprising:
a parameter detector configured to detect a parameter that correlates with one or both of a driving force of the drive device and a braking force of the braking device;
a vibration waveform generator configured to generate a vibration waveform;
a vibrator configured to cause vibration of air around an occupant with the vibration waveform; and
a gain adjuster configured to increase an output gain of the vibration waveform in accordance with an increase in an absolute value of a differential value of the parameter.

2. The information communication device according to claim 1, wherein the vibration waveform comprises a dominant frequency included in a frequency band of 100 Hz to 400 Hz.

3. The information communication device according to claim 1, wherein
the gain adjuster is configured to
maximize an increase rate of the output gain relative to the increase in the absolute value of the differential value in a region where the absolute value of the differential value is minute, and
decrease the increase rate in accordance with the increase in the absolute value of the differential value.

4. The information communication device according to claim 1, wherein the gain adjuster is configured to set the output gain to allow a sound pressure generated by the vibration caused by the vibrator not to become dominant over background noise near an ear of at least one of the occupant in traveling of the vehicle.

5. The information communication device according to claim 1, wherein
the vehicle comprises an inputting device, the inputting device being configured to
perform an acceleration operation in accordance with an operation of depressing a single pedal from a predetermined position, and
perform a braking operation in accordance with an operation of returning the single pedal from the predetermined position, and
the gain adjuster is configured to set the output gain set in accordance with the operation of returning the single pedal to be larger than the output gain set in accordance with the operation of depressing the single pedal.

6. The information communication device according to claim 2, wherein
the gain adjuster is configured to
maximize an increase rate of the output gain relative to the increase in the absolute value of the differential value in a region where the absolute value of the differential value is minute, and
decrease the increase rate in accordance with the increase in the absolute value of the differential value.

7. The information communication device according to claim 2, wherein the gain adjuster is configured to set the output gain to allow a sound pressure generated by the vibration caused by the vibrator not to become dominant over background noise near an ear of at least one of the occupant in traveling of the vehicle.

8. The information communication device according to claim 2, wherein
the vehicle comprises an inputting device, the inputting device being configured to
perform an acceleration operation in accordance with an operation of depressing a single pedal from a predetermined position, and
perform a braking operation in accordance with an operation of returning the single pedal from the predetermined position, and
the gain adjuster is configured to set the output gain set in accordance with the operation of returning the single pedal to be larger than the output gain set in accordance with the operation of depressing the single pedal.
